(19) United States
(12) Patent Application Publication
(10) Pub. No.: US 2015/0240946 A1
(43) Pub. Date: Aug. 27, 2015

(54) METHOD FOR SHUTTING AN OPENING IN A BODY, IN PARTICULAR IN A DOOR ACTUATOR

(71) Applicant: DORMA DEUTSCHLAND GMBH, Ennepetal (DE)

(72) Inventor: Alexander Hellwig, Ennepetal (DE)

(21) Appl. No.: 14/432,525

(22) PCT Filed: Sep. 17, 2013
(86) PCT No.: PCT/EP2013/002794

§ 371 Date: Mar. 31, 2015

(30) Foreign Application Priority Data
Oct. 10, 2012 (DE) 10 2012 109 623.6

(51) Int. Cl. F16J 13/02; E05F 3/00; E05F 15/50

(52) U.S. Cl. CPC F16J 13/02; E05F 15/50; E05F 3/00

(57) ABSTRACT

A method for closing an opening in a body, for example in a housing of a door operator, and such a closure arrangement, a closure element being provided for this purpose, which is inserted into the opening, where the method includes providing the closure element having a pot-shaped embodiment such that the closure element includes a bottom and a surrounding border extending upwards from the extension plane of the bottom, forming the opening with a circumferential edge projecting into the opening, behind which edge an undercut area is formed, and joining the closure element into the opening such that the bottom points towards the inside, and widening the surrounding border into the undercut area.

### TECHNICAL FIELD

The present invention relates to a method for closing an opening in a body, for example in a housing, for this purpose a closure element being provided, which is inserted into the opening.

Such an opening to be closed may be provided for example in a housing of a door operator for operating a door, in order to seal an internal compartment of a housing in a pressure-tight manner. For this purpose during installation, once the different mechanical components have been disposed in the internal compartment of the housing and once the housing has been filled with a pressure medium, the closure element may be inserted for example in the opening, which element seals the internal compartment of the housing in a pressure-tight manner. Usually in this case, the closure element is configured as a screwed sealing plug.

### BACKGROUND

The document DE 20 2008 008 921 U1 reveals a door operator for operating a swing door, with a housing, in which at the end side an opening is formed in the shape of a cylindrically shaped pocket. A screwed sealing plug can be screwed into this cylindrically shaped pocket for sealing the internal compartment of the housing of the door closer in a pressure-tight manner.

Basically, together with a closure element in the shape of a screw, a sealing element can be advantageously fitted in the opening of the body such as to create a sufficient sealing effect. Disadvantageously however, a thread is required at both the closure element and the opening of the body, which causes considerably higher manufacturing costs. Another disadvantage of the known door operators is that, when mounting the door operator, the operational step of screwing the screwed sealing plug into the housing of the door operator, requires a certain period of time, which results in considerable mounting costs when considering the annual amount of door operators.

The document DE 10 2010 017 570 A1 shows another closure arrangement for closing an opening in the housing of a door operator, and the use of an arched cover is proposed as a closure element, which is disposed under plastic deformation in the opening for sealing the internal compartment in a pressure-tight manner. The cover has an arched surface against which a tool acts for pressing the arched surface to a flat shape. The exterior diameter of the closure element increases during this procedure and reaches into a surrounding groove, such that the closure element is disposed in a self-retaining manner in the opening by engagement in the groove. It is furthermore proposed to fit a sealing element into the groove prior to inserting a closure element such that, after the plastic deformation of the arched surface of the cover, the sealing element sits in a sealing manner in the groove, into which, under radial expansion, likewise the exterior border of the closure element is pressed.

When an increased internal pressure builds up in the internal compartment of the housing of the door operator, the closure element cannot be reliably retained in the opening of the body and this circumstance may result in leakages, which in turn may lead to a loss of pressure in the internal compartment of the housing and therefore should be avoided. In case a plastically deformable closure element with a central arched surface in the shape of a cover is provided, a sufficient sealing effect may possibly not be achieved.

### BRIEF SUMMARY

A simple method is provided for closing an opening in a body, as well as a closure arrangement for this purpose, wherein the opening is sealed in a simple and pressure-tight manner by means of the method, respectively by means of the closure arrangement.

According to the invention, the method initially intends the provision of the closure element having a pot-shaped configuration, such that the closure element includes a bottom and a surrounding border extending from the extension plane of the bottom, wherein furthermore, the configuration of the opening is intended with a circumferential edge reaching into the opening, behind which an undercut area is formed, and joining the closure element into the opening is intended such that the bottom is oriented to the inside, and finally the method comprises a step of widening the surrounding border into the undercut area.

The advantageous embodiment of the closure element for a positive arrangement in the opening provides the advantage of being able to arrange the closure element in the opening in a simple manner, wherein the closure arrangement can be configured already in a pressure-tight manner by means of the closure element. In the event excess pressure builds up in the internal compartment of the body, said pressure acts against the bottom of the closure element, and the border of the closure element guided into the undercut area leads the force, introduced into the bottom by means of the pressure, into the circumferential edge of the opening. The circumferential edge may border the opening in the body towards the outside such that the closure element is completely positively seated in the opening.

Prior to the deformation of the surrounding border of the closure element, the latter has for example a cylindrically shaped form with an exterior diameter which is smaller than the interior diameter of the opening, which is determined by the circumferential edge projecting towards the inside.

Preferably, the opening in the body may be configured rotation-symmetrically. However, in addition to a round opening, the latter may be determined by any arbitrary shape. The opening may be for example configured elliptical, triangular, square, in particular rectangular or polygonal. In this case, introducing the surrounding border into the undercut area of the opening remains thereby affected by the shape of the contour of the opening.

With a particular advantage, the widening of the surrounding border may be executed under a plastic change of shape. A tool may be provided for this purpose, by means of which the surrounding border may be widened, in particular after the closure element has been inserted into the opening, and in that the tool is subsequently pressed into the pot-shaped closure element. Prior to the action of the tool, the border of the closure element may be cylindrically shaped, in order to fit into the opening of the body. If the closure element is disposed in the opening, the tool may act from the border inside against the surrounding border for widening the border and for guiding it into the undercut area. In this case, the tool may have a contour, which already corresponds to the contour of the pressed-in closure element. In this case, the tool acts in particular with all its circumference against the border such that the latter experiences the required widening by means of the axial guidance of the tool into the opening.

For achieving a satisfactory sealing of the opening by means of the closure element, the method may comprise the provision of a sealing element, which is inserted prior to joining the closure element in the opening. The opening may include a contour adjoining the circumferential edge towards the inside, which almost corresponds to the contour of the widened border such that the former can bear against the exterior contour. The adjoining contour may for example form a cone-shaped section and the sealing element may be inserted into the lower channel of the cone-shaped section in the transition to a bottom section of the opening. As an alternative, the sealing element may be configured as a sealing tape, which may be adapted to the contour between the bottom section and the circumferential edge, and may be likewise inserted prior to joining the closure element in the opening. If the sealing element is executed as an O-ring-seal, it may be inserted either in the transition of the bottom section to the exterior contour or in the undercut area such that the sealing element is pressed into the undercut area between the border and the circumferential edge. It is likewise conceivable to provide a groove in the contour of the opening, for example by means of a cutting process, into which groove for example an O-ring-shaped sealing element or a sealing tape may be inserted. If subsequently the closure element is inserted and the border is widened, the latter is pressed on the outside against the sealing element inserted into the groove.

The method offers the advantage of a simply manufactured closure arrangement, wherein the means for closing the opening can be provided in a simple manner. The pot-shaped closure element may be for example deep-drawn from a sheet metal material for shaping the latter with the bottom and the surrounding border. When deep-drawing, from the initially plane sheet metal, the border may be drawn-and-ironed from the border area of the bottom, for example while forming a cylindrically shaped section. It is likewise advantageous, if the opening and the circumferential edge bordering the opening with the undercut area in the body are manufactured in a casting process or a metal cutting process. The method for forming a closure arrangement for closing an opening in a body may be utilized particularly advantageously for closing the housing of a door operator. In this case, the housing of the door operator constitutes the body with the opening, wherein the closure element closes an internal compartment of the door operator in a pressure-tight manner, which is in particular filled with a pressure medium. In this case, the closure element and the inventive arrangement of the closure element in the opening may replace a screwed sealing plug, which usually closes the opening and needs to be screwed into the opening.

Furthermore, the present invention is directed to a closure arrangement for closing an opening in a body, for example in a housing, wherein the closure element is intended to be inserted into the opening, and wherein the closure element has a pot-shaped configuration and a bottom and a surrounding border extending upwards from the extension plane of the bottom, and it is provided that the opening has a circumferential edge reaching into the opening, behind which an undercut area is formed, and wherein the closure element is joined into the opening with its bottom being oriented to the inside, and wherein the surrounding border is introduced into the undercut area by widening. Consequently, from the outside of the opening in the body, the closure element with the bottom and the surrounding border is visible, wherein the bottom points towards the inside into the opening, and wherein the surrounding border abuts against the undercut area of the opening, which presents itself by means of a circumferential edge pointing to the inside.

The closure element may be manufactured from a metallic material and the surrounding border may be guided into the undercut area while the closure element experiences a plastic deformation.

With additional advantage, a sealing element may be disposed between the opening and the closure element and in particular configured as an O-ring-seal. As an alternative, the closure arrangement may include a sealing tape, which extends in the area of the contour between the circumferential edge and the bottom section of the opening and surrounds the border of the closure element on the outside.

With particular advantage, the body may be configured by means of the housing of a door operator, wherein the closure element closes an internal compartment of the door operator in a pressure-tight manner, which compartment is in particular filled with a pressure medium.

Furthermore, the present invention is directed to a door operator with a housing, in which an opening is provided, and wherein a closure element is intended to be inserted into the opening, and wherein the closure element has a pot-shaped configuration, and includes a bottom and a surrounding border extending upwards from the extension plane of the bottom, wherein the opening has a circumferential edge reaching into the opening, behind which edge an undercut area is formed, and wherein the closure element is joined into the opening with the bottom being oriented to the inside, and wherein the surrounding border is introduced into the undercut area by widening. Further features, which are described in conjunction with the method for closing the opening in the body, as well as the associated advantages accompanied by the further features, are obviously likewise considered for the inventive door operator.

### BRIEF DESCRIPTION OF THE DRAWINGS

Hereinafter, further measures enhancing the invention will be illustrated in the following in detail in conjunction with the description of one preferred embodiment of the invention based on the Figures, in which:

FIG. 1 shows a view of the body with the opening, which is in an unclosed condition by a closure element and a sealing element,

FIG. 1a shows a detailed view of the opening in the body,

FIG. 2 shows a view of the body with the closure element being inserted into the opening,

FIG. 3 shows the method step of widening the border of the closure element by means of a tool, and

FIG. 4 shows a view of the body with the opening being closed by means of the closure element.

### DETAILED DESCRIPTION

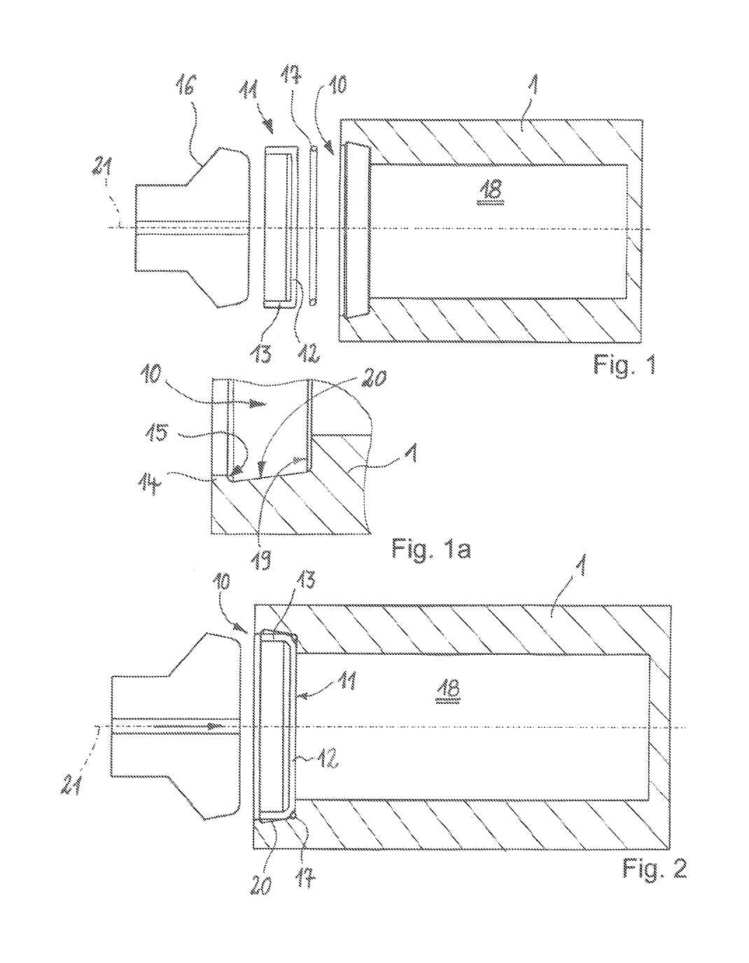

FIG. 1 shows a closure arrangement for closing an opening 10 in a body 1, and the body 1 is just diagrammatically illustrated and may constitute for example the housing 1 of a door operator, which may be fastened to a door or to a door leaf of a door, and serves to operate the door leaf.

By way of example, the opening 10 is configured to be round and extends about a longitudinal axis 21. An internal compartment 18, which is accessible through the opening 10, is configured inside the body 1

For executing the method for closing the opening 10, a closure element 11 and a sealing element 17 are provided, which are shown as not being installed, and are disposed in front of the opening 10. The method for joining the closure element 11 in the opening 10 is accomplished by means of a tool 16, which is likewise shown as being disposed in front of the closure element 11.

The closure element 11 is configured as a metal deep drawn component and has a bottom 12 and a surrounding border 13, which is drawn and ironed from the bottom 12, and is almost cylindrically configured in the un-deformed condition. The illustrated sealing element 17 is configured as an O-ring-seal.

As shown in FIG. 1a, the opening 10 has a circumferential edge 14, behind which an undercut area 15 is configured. The undercut area 15 is adjoined by a contour 20, the diameter thereof tapers in the direction of a bottom section 19. The bottom section 19 just constitutes a plane surrounding border, which, in further progress of the body 1, transitions into the internal compartment 18.

The inventive method for closing the opening 10 with the closure element 11 is described in conjunction with the following FIGS. 2, 3 and 4.

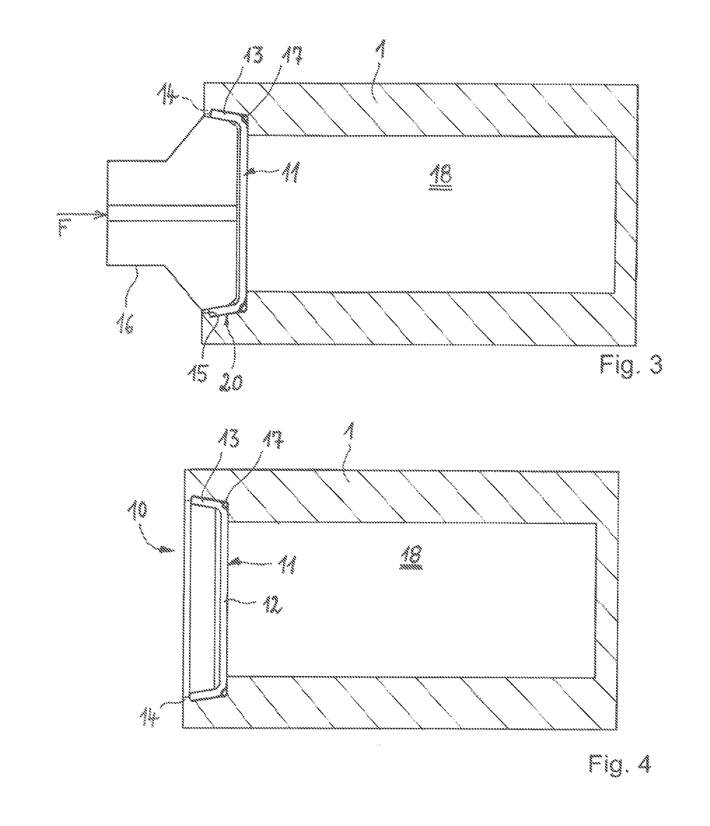

FIG. 2 shows the body 1 with the closure element 11, which together with the sealing element 17 are already inserted into the opening 10. It can be seen in this case, that the surrounding border 13, still in a cylindrically shaped manner, extends upwards from the bottom 12 of the closure element 11, and consequently does not bear against the contour 20 of the opening 10. On account of its cylindrically shaped form, the surrounding border 13 has an exterior diameter, which allows for the closure element 11 to pass through the circumferential edge 14 projecting to the inside, which has a same or a slightly larger diameter than the outside of the surrounding border 13. Subsequently, the tool 16 is pressed into the closure element 11 in a movement, which is indicated by an arrow, along the longitudinal axis 21, as shown in the following FIG. 3.

FIG. 3 shows the body 1 with the closure element 11 and the sealing element 17, wherein the tool 16 is pressed into the closure element 11 while applying a pressure force F. In this case, the surrounding border 13 widens in such a way that the latter reaches behind the circumferential edge 14 and thus gets secured in the undercut area 15 formed by the latter.

Once the tool 16 is removed, after the surrounding border 13 is pressed behind the circumferential edge 14, the closure arrangement is accomplished according to FIG. 4. The internal compartment 18 of the body 1 is in particular sealed via the sealing element 17 in a pressure-tight manner, and in case an excess pressure in the internal compartment 18 acts against the bottom 12, the surrounding border 13 remains in a reliably retained arrangement behind the circumferential edge 14. In particular in case of a pressure load from the internal compartment 18 against the bottom 12, the surrounding border 13 is preferably widened, such that even in case of an elastic, for example even likewise with a slight plastic deformation of the closure element 11, it is ensured that the latter does not leave the opening 10. In the arrangement shown, the sealing element 17 is slightly squeezed when the closure element 11 is inserted, such that it is able to fulfill its sealing task without being damaged.

In conjunction with the above described FIGS. 1 to 4, the body is embodied as a housing and encloses the internal compartment 18. The body 1 is just diagrammatically shown and may constitute the housing of a door operator, wherein the opening 10 constitutes a closure opening at an end side, through which a locking mechanism is inserted into the door operator and wherein the internal compartment 18 is filled with pressure fluid prior to closing the opening 10 with the closure element 11.

The invention in its configuration is not limited to the above presented preferred embodiment. On the contrary, a number of variants are conceivable, which make use of the illustrated solution, even with basically different types of embodiments. All features and/or advantages including the constructional details or spatial dispositions, resulting from the claims, the description or the drawings, may be essential to the invention, both by themselves and in the most various combinations.

1. A method for closing an opening in a body, for example in a housing, a closure element being provided for this purpose, which is inserted into the opening, wherein the housing of a door operator constitutes the body, wherein the closure element in particular closes an internal compartment of the door operator filled with a pressure medium in a pressure-tight manner, and wherein the method comprises the steps of:
providing the closure element having a pot-shaped embodiment such that the closure element includes a bottom and a surrounding border extending upwards from the extension plane of the bottom,
forming the opening with a circumferential edge projecting into the opening behind which edge an undercut area is formed, and
joining the closure element into the opening such that the bottom points towards the inside, and
widening the surrounding border into the undercut area.

2. The method according to claim 1, wherein the widening of the surrounding border is realized under plastic deformation.

3. The method according to claim 1, wherein a tool is provided, by means of which the surrounding border is widened, wherein the tool is pressed into the pot-shaped closure element.

4. The method according to any of the claim 1, wherein a sealing element is provided, which is inserted into the opening prior to joining the closure element.

5. The method according to claim 1, wherein, for providing the pot-shaped closure element, a sheet metal is deep drawn, in order to execute the latter with a bottom and the surrounding border and/or wherein the circumferential edge bordering the opening is brought to fit into the undercut area in the body by means of a casting method or a metal cutting method.

6. A closure arrangement for closing an opening in a body, for example a housing, wherein a closure element to be inserted into the opening is provided, wherein the body is formed by means of the housing of a door operator, and wherein the closure element closes in particular an internal compartment of the door operator filled with a pressure medium in a pressure-tight manner, wherein
the closure element is configured to be pot-shaped and includes a bottom and a surrounding border extending from the extension plane of the bottom, and
the opening includes a circumferential edge projecting into the opening, behind which edge an undercut area is formed,
the closure element, with the bottom pointing towards the inside, is joined into the opening and wherein the surrounding border is guided into the undercut area by widening.

7. The closure arrangement according to claim 6, wherein the closure element is configured from metal material, wherein the surrounding border is guided into the undercut area by means of plastic deformation of the closure element.

8. The closure arrangement according to claim 6, wherein a sealing element configured as an O-ring-seal is disposed between the opening and the closure element.

9. A door operator having a housing, in which an opening is provided, and wherein a closure element to be inserted into the opening is provided, wherein
the closure element is configured to be pot-shaped and includes a bottom and a surrounding border extending upwards from the extension plane of the bottom, and
the opening includes a circumferential edge projecting into the opening behind which edge an undercut area is formed,
the closure element, with the bottom pointing towards the inside, is joined into the opening, and wherein the surrounding border is guided into the undercut area by widening.

10. The door operator according to claim 9 with a closure arrangement for closing an opening in a body, for example a housing, wherein a closure element to be inserted into the opening is provided, wherein the body is formed by means of the housing of a door operator, and wherein the closure element closes in particular an internal compartment of the door operator filled with a pressure medium in a pressure-tight manner, wherein the closure element is configured to be pot-shaped and includes a bottom and a surrounding border extending from the extension plane of the bottom, and the opening includes a circumferential edge projecting into the opening, behind which edge an undercut area is formed, and the closure element, with the bottom pointing towards the inside, is joined into the opening and wherein the surrounding border is guided into the undercut area by widening.
